(19) United States
(12) Patent Application Publication
(10) Pub. No.: US 2018/0222093 A1
(43) Pub. Date: Aug. 9, 2018

(54) CASTING DEVICE FOR APPLYING A FOAMING REACTION MIXTURE

(71) Applicant: Covestro Deutschland AG, Leverkusen (DE)

(72) Inventors: Dirk Brüning, Leverkusen (DE); Achim Symannek, Leichlingen (DE); Klaus Franken, Bergisch Gladbach (DE); Stephen Schleiermacher, Pulheim (DE); Thomas Herweg, Wipperfürth (DE)

(73) Assignee: Covestro Deutschland AG, Leverkusen (DE)

(21) Appl. No.: 15/749,364

(22) PCT Filed: Aug. 3, 2016
(86) PCT No.: PCT/EP2016/068574

§ 371 Date: Jan. 31, 2018

(30) Foreign Application Priority Data
Aug. 4, 2015 (EP) 15179653.9

(51) Int. Cl. B29C 44/46; B05C 5/02; B29C 44/50; B29C 44/34

(52) U.S. Cl. CPC B29C 44/461; B05C 5/0254; B29K 2075/00; B29C 44/3402; B29C 44/505

(57) ABSTRACT

The invention relates to a casting device for applying a foaming reaction mixture, to at least a partial width of a cover layer, wherein the casting device comprises: a supply connection for feeding in the reaction mixture; at least one exit slit extending in a transverse direction for the exiting of the reaction mixture; two slit plates arranged opposite one another, wherein a slit space extends between the slit plates in a vertical direction above the exit slit. A supply channel connected to the supply connection is formed between the slit plates, which closes off the slit space above the exit slit in the vertical direction The supply channel has a channel cross-section, the main dimension of which is larger that the width of the slit space. The reaction mixture can be introduced into the slit space to distribute the reaction mixture over the length of the supply channel.

The invention relates to a pouring device for applying a foaming reaction mixture at least comprising polyol and isocyanate over at least part of the width of a facing layer, in particular for producing a composite element, wherein the pouring device comprises a feed port for feeding in the reaction mixture and forms an outlet slot extending in a transverse direction for discharge of the reaction mixture, and wherein the pouring device comprises two opposingly arranged slot plates, wherein a slot space between the slot plates extends in a vertical direction above the outlet slot.

### BACKGROUND OF THE INVENTION

EP 2 216 156 A1 discloses a pouring device for applying a foaming reaction mixture comprising polyol and isocyanate to produce composite elements. Composite elements comprise at least one facing layer and for the most part two facing layers guided parallel to one another, and the reaction mixture is applied to one of the facing layers, in particular to the inside of a lower facing layer guided on the underside. After application of the reaction mixture, the latter foams until the foam front arrives against the inside of the opposing facing layer. The facing layers are guided in a parallel belt installation until the reaction mixture has cured into a substantially deformation-resistant body which forms the polyurethane foam core between the two facing layers. This continuous production of composite elements is distinguished by high output, and the continuously produced composite element may be separated into corresponding sandwich elements after passage through the parallel belt installation.

The quality of the sandwich elements depends essentially on how uniformly the polyurethane foam core is formed between the two facing layers and how well it fills the volume. The adhesion of the facing layers to the boundary surface of the polyurethane foam core also plays a significant role in assessing the quality of the composite element. If multiple strands of reaction mixture are applied onto the inside of the facing layer next to one another over the width of the facing layer, foaming of the reaction mixture leads to multiple foam fronts, which meet one another laterally and between which boundary surfaces consequently form. The consequence is uneven foaming of the reaction mixture with multiple foam fronts and in the cured state the polyurethane foam core has a non-homogeneous texture. Turbulence forms, with bubbles and voids, wherein the cell orientation of the foam is generally also not uniform. This reduces the quality of the foam structure, and may result in too little adhesion on the inside of the facing layers, leading to reduced composite element quality, in particular with regard to mechanical and/or thermal characteristics, surface quality and/or compressive strength.

GB 1 282 876 A discloses a pouring device with a flat film die which allows linear application, oriented over the width of the facing layer, of a reaction mixture comprising polyol and isocyanate. In the configuration of such flat film dies, the important factor is to achieve maximally uniform application of the reaction mixture to the facing layer, in order to ensure similarly uniform foaming. It is not sufficient, for this purpose, to generate the same volumetric flow rate at each position of the outlet slot over the length thereof in the transverse direction, since the transit time of the reaction mixture through the pouring device is likewise a decisive factor. Parts of the reaction mixture which travel over a longer transit path through the pouring device foam earlier after being poured onto the facing layer than parts of the reaction mixture which have taken a quicker, more direct path through the pouring device. The crucial factor is thus the transit time of the reaction mixture through the pouring device, which should as far as possible be the same for each thread of the reaction mixture stream.

The pouring device disclosed in GB 1 282 876 A comprises a plurality of feed ports which open in punctiform manner into a slot space formed between the slot plates. In operation the reaction mixture is fed through the feed ports into the slot space, and the slot space takes the form of a triangle, and the elongate lower base edge of the triangle forms the outlet slot. There is thus straight away no possibility of each unit of volume of the reaction mixture passing through the pouring device within the same period of time, since a shorter reaction mixture through-flow time is achieved in the middle of the base edge directly below the feed port than in the peripheral regions. A further disadvantage consists in the fact that the triangular shape does not allow a uniform outflow speed to be established for outflow of the reaction mixture out of the outlet slot, since in the peripheral region of the triangular structure of the slot spaces a higher pressure drop prevails than in the middle due to the longer flow path. As a result of the constant pressure difference for each flow path from inflow into the triangular slot to discharge, ideally a Gaussian distribution of the flow rate is established along the lower base edge of each of the triangular pouring molds, the consequence of which is a non-uniform discharge quantity and uneven foaming of the reaction mixture.

Composite elements of the type of interest here are also denoted sandwich elements or insulation panels and generally serve as components for sound proofing, for indoor swimming pool construction or for cladding construction. The facing layers may here form metal webs or plastics webs, depending on the intended purpose of the composite elements.

### SUMMARY OF THE INVENTION

The object of the invention is the further development of a pouring device for applying a foaming reaction mixture, with which uniform foaming of the reaction mixture is to be achieved over the width of the facing layer. In particular, the pouring device is intended to be formed in such a way that each element of volume of the reaction mixture passes through the pouring device over the length of the outlet slot thereof over an identical time period.

This object is achieved on the basis of a pouring device for applying a foaming reaction mixture according to the preamble of claim 1 and with an installation for applying a foaming reaction mixture with a plurality of pouring devices as claimed in claim 10 with the respective characterizing features. Advantageous further developments of the invention are indicated in the dependent claims.

The invention includes the technical teaching that a feed duct connected to the feed port is formed between the slot plates, which feed duct terminates the slot space above the outlet slot in the vertical direction (H), wherein the feed duct comprises a duct cross-section with a main dimension which is greater than the width of the slot space, such that the reaction mixture may be introduced into the slot space distributed over the length of the feed duct.

The nub of the invention is a specific configuration of the pouring device with guidance of the reaction mixture between the feed port and the outlet slot which is further developed in such a way that each unit of volume of the reaction mixture may flow through the pouring device with the same transit time between the feed port and the outlet slot. In other words, each thread of the reaction mixture stream displays the same residence time between the feed port and the outlet slot. This solution is achieved with a feed duct which adjoins the feed port on the inside of the pouring device and wherein the feed duct is formed between the slot plates.

Formation “between” the slot plates here describes a configuration of the feed duct which is formed either in a first slot plate, in an opposing second slot plate or in both slot plates by a corresponding geometry. The cross-section of the feed duct does not here have to be round, but rather may also be semicircular, trapezoidal, elliptical or the like. The feed duct may in particular also be formed in that a corresponding recess, for example with a semicircular duct cross-section, is formed in just one of the two slot plates. The opposing slot plate may in this case have a plane face and laterally delimit the feed duct or the opposing slot plate has the same or a modified mirroring recessed geometry, in order to configure the duct cross-section symmetrically over the slot space. In any event, given the way the word is used here, the formation of the feed duct “between” the slot plates describes any possible recess shape and other geometries in the surface of the slot plate.

It goes without saying that the slot space may also be incorporated both into both slot plates or indeed just unilaterally in one of the slot plates. It is in particular also possible to introduce the feed duct with the feed port and the slot space into just one slot plate, since the opposing slot plate may then particularly advantageously be of completely plane construction.

The main dimension of the duct cross-section is in this case wider than the width of the slot space, such that the reaction mixture may reach the end of the feed duct, wherein the duct cross-section of the feed duct is configured such that a defined pressure drop in the flow mixture is produced as the distance from the feed port increases. The reaction mixture leaves the feed duct distributed uniformly over the entire length thereof and enters in the manner of a flow curtain into the slot space, which follows below the feed duct. In this way, linear outflow of the reaction mixture from the feed duct is produced, such that the reaction mixture may be introduced into the slot space distributed over substantially the entire length of the feed duct. The length of the feed duct extends in the transverse direction over the length which also corresponds to the length of the outlet slot. In particular, the ends of the outlet slot terminate with the ends of the feed duct.

According to one advantageous further development of the pouring device according to the invention, the duct cross-section is configured to become smaller as the distance from the feed port increases. The duct cross-section is advantageously at its largest at the connection point to the feed port and decreases progressively as the distance from the feed port increases. The feed duct may in the same way extend on both sides away from the feed port in the transverse direction, and the feed duct has its largest cross-section subsequent to the feed port. The respective outer ends of the feed duct may have such a small cross-section that it terminates with the width of the slot space. This prevents an elevated amount of reaction mixture from being able to exit the outlet slot at the ends of the feed duct.

The width of the slot space may be the same as the width of the outlet slot or the width of the outlet slot is at least slightly less than the width of the slot space, in particular in order additionally to achieve a residual pressure difference in the reaction mixture before and after passage through the outlet slot, so resulting in further evening-out of reaction mixture discharge.

In a further embodiment, the width of the outlet slot may be embodied to increase in size starting from the width of the slot space towards the outlet orifice, in order to reduce discharge velocity or to counter an increase in volume at the start of foaming.

It is also advantageous for the slot space to have a width which is formed constantly over the substantially entire two-dimensional extent of the slot space between the slot plates, wherein small local deviations in width from the width which is otherwise everywhere the same may however arise, for example at points at which screw elements extend through the slot space. It is additionally advantageous for the feed duct to be curved, such that the height of the slot space becomes smaller as the distance increases from the feed port above the outlet slot. As the distance from the feed port increases, the height of the slot space between the outlet slot and the feed duct thus reduces, such that the flow resistance and transit time between the feed duct and the outlet slot fall. At the same time, however, flow resistance increases over a longer distance through the feed duct, such that the overall pressure drop remains constant. Because the flow rate in the feed duct is higher than in the slot, it is ensured overall that between the feed port and the outlet slot the reaction mixture experiences the same transit time over the entire length of each flow path.

The changing duct cross-section of the feed duct and the curvature for adjusting the height dimension of the slot space above the outlet slot are matched to one another in such a way that the same transit time is produced for the reaction mixture over the entire length of the outlet slot. It is thus also feasible for the curvature of the feed duct to increase in magnitude as the distance from the feed port increases. The feed duct may for example display roughly parabolic curvature, wherein the curvature increases as the distance from the feed port increases. In this way, the feed duct roughly assumes the shape of a coat hanger, such that in particular the peripheral boundary of the two-dimensional slot space deviates from a triangular shape. Rather, the slot space extends between the outlet slot and the feed duct with an overall constant width, and the constant width over the entire two-dimensional extent of the slot space additionally gives rise to evening-out of flow velocity. A particular distinguishing feature achieved in this case is that the reaction mixture has the same discharge velocity in the transverse direction over the entire length of the outlet slot.

Matching the size ratios and geometries of the components of the pouring device involved in guiding the reaction mixture is a procedure which is for example computer-assisted, preferably using computer fluid dynamics calculation (CFD). The length of the feed port and/or the length of the feed duct and/or the height of the slot space in the vertical direction above the outlet slot are in this case determined such that the elements of volume of the reaction mixture may experience the same transit time over the entire length of the outlet slot, each element of volume has the same velocity value over the length of the outlet slot and the transit time of the reaction mixture through the pouring device is less than the reaction time. This means that the transit time of the reaction mixture from the mixing head, which is upstream of the feed port, and the outlet slot is selected to be so low that foaming does not start prior to discharge from the outlet slot.

The invention is further directed to an installation for applying a foaming reaction mixture at least comprising polyol and isocyanate over at least part of the width of a facing layer, in particular for producing a composite element, comprising a plurality of pouring devices as claimed in one of claims 1 to 9, wherein the outlet slots of the pouring devices extend in a common transverse direction or in an arch over the facing layer.

The nub of the installation according to the invention is a juxtaposition of multiple pouring devices according to the invention, such that the total length of the outlet slot in the common transverse direction is adapted to the facing layer width. This makes it possible to make the pouring device smaller and thus to reduce transit time, and the plurality of individual slot spaces, which are delimited at the top by respective feed ducts, form in themselves individual pouring devices, wherein the length of the entire outlet slot does not however have to correspond to the facing layer width. Each of the individual pouring devices may comprise a separate feed port, which is fed by in each case separate mixing heads, wherein advantageously the possibility also arises of supplying the plurality of feed ports using one mixing head. To feed the reaction mixture to the feed ports, a hose system or a manifold system may be provided.

According to one advantageous further development of the installation, the slot plates of the plurality of pouring devices may be configured together in one piece on one or each side of the slot space. In the case of a one-piece configuration, the various feed ducts may be fed via a central feed port and a downstream, for example star-shaped, manifold system. The slot plates may be shaped in such a way that a plurality of feed ducts and adjoining slot spaces below the feed ducts are formed. It is in particular feasible to assign a separate feed port to each feed duct.

It is also advantageously possible for the ends remote from the feed ports of the feed ducts of the plurality of pouring devices to adjoin one another. If the transit time and the discharge velocity of the reaction mixture out of the outlet slot of the individual pouring devices are identical over the respective slot length in the transverse direction, it is to be expected that the transit time and the discharge velocity of the reaction mixture are identical along the entire outlet slot. This ensures that constant, uniform application of the reaction mixture is also achieved overall over the entire facing layer width. The total length of the outlet slot in this case virtually corresponds to the facing layer width, wherein provision may be made for the reaction mixture application width to be selected to be slightly smaller than the facing layer width. For example, the facing layer may have a width of 120 cm, and the total length of the outlet slot amounts for example to 115 cm and extends in widthwise over the facing layer. The smaller reaction mixture application width in relation to the width of the facing layer is preferably selected in order to prevent unintentional discharge outside the facing layer. Since the reaction mixture also foams and thus expands over the facing layer width, the peripheral region of the facing layer is thus also reached and covered.

In the installation, the at least one pouring device may be accommodated tiltably about an axis for example parallel to the facing layer and perpendicular to the conveying direction of the facing layer, such that the device does not have to apply the reaction mixture exactly perpendicularly onto the facing layer, but rather for example in leading or trailing manner By way of the tilted position, the angle between the discharge film and the facing layer may be adjusted to produce optimum reaction mixture flow conditions in the region of impact.

In the installation, the at least one pouring device may moreover be arranged so as to be rotatable about an axis perpendicular to the lower facing layer. Depending on the selected angular position of the pouring device and thus the angle between the outlet slot and the conveying direction of the facing layer, the application width of the reaction mixture is adapted to the facing layer width and/or guidance of the rising foam, which is formed from the reaction mixture, is favorably influenced when the upper facing layer is reached.

Where a plurality of pouring devices are juxtaposed, they are accommodated for example on an adjustable carrier, wherein, as described above, the plurality of pouring devices may also be constructed in a structural unit, for example with common slot plates.

In the case of the use of a plurality of pouring devices, the latter are preferably arranged in such a way that the outlet slots of the individual pouring devices form a common, continuous and straight or bent outlet slot. In a further developed embodiment, these may namely also be rotated relative to one another in such a way that the individual outlet slots are each at an angle to one another and overall form a polygon or an arc. This results in even better adaptability to the facing layer width and/or guidance of the rising foam on reaching the upper facing layer.

Provision is further advantageously made for the reaction mixture to be provided with gas loading and in particular with air loading. Air loading prevents the slot space from becoming clogged in particular in the regions of weaker reaction mixture through-flow. To this end, the installation comprises a gas loading device, with which the reaction mixture may be loaded with a gas. The gas loading device is in this case configured such that gas loading may be effected with air, with nitrogen, with carbon dioxide or with noble gas, in particular argon or helium. Using in particular dried air or nitrogen, it is advantageously ensured that the thin slot space between the slot plates does not become clogged with prematurely foaming reaction mixture.

### PREFERRED EXEMPLARY EMBODIMENT

Further measures which improve the invention are described in greater detail below with reference to the figures, together with the description of a preferred exemplary embodiment of the invention. In the figures:

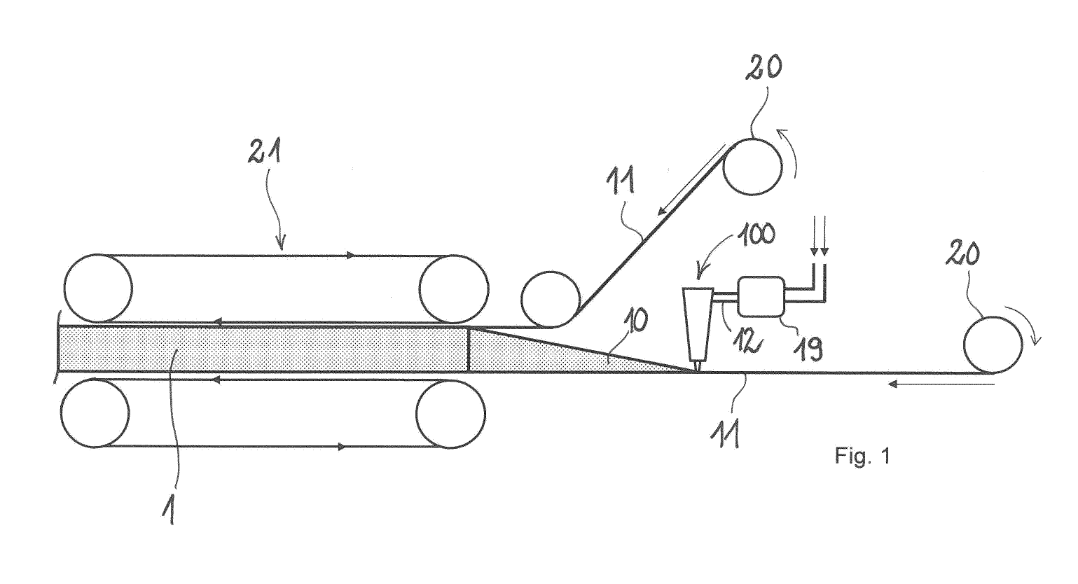

FIG. 1 is an overall view of the installation with a pouring device and facing layer feed and a double belt conveying installation,

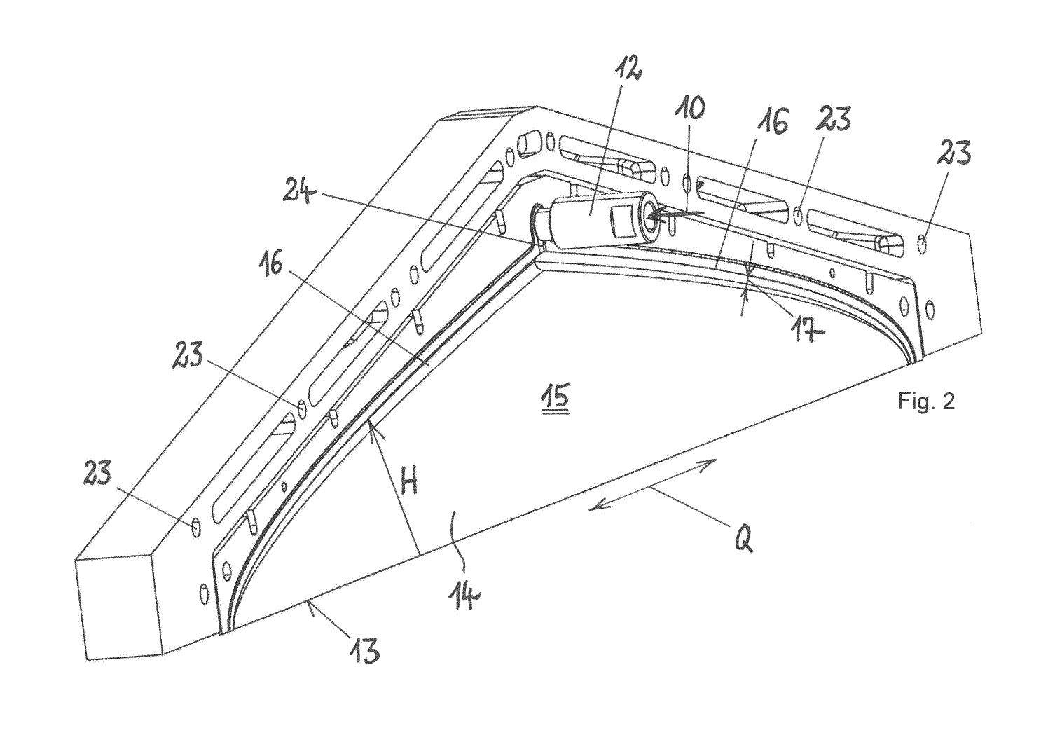

FIG. 2 is a perspective representation of a slot plate 14 from that side which two-dimensionally delimits the slot space,

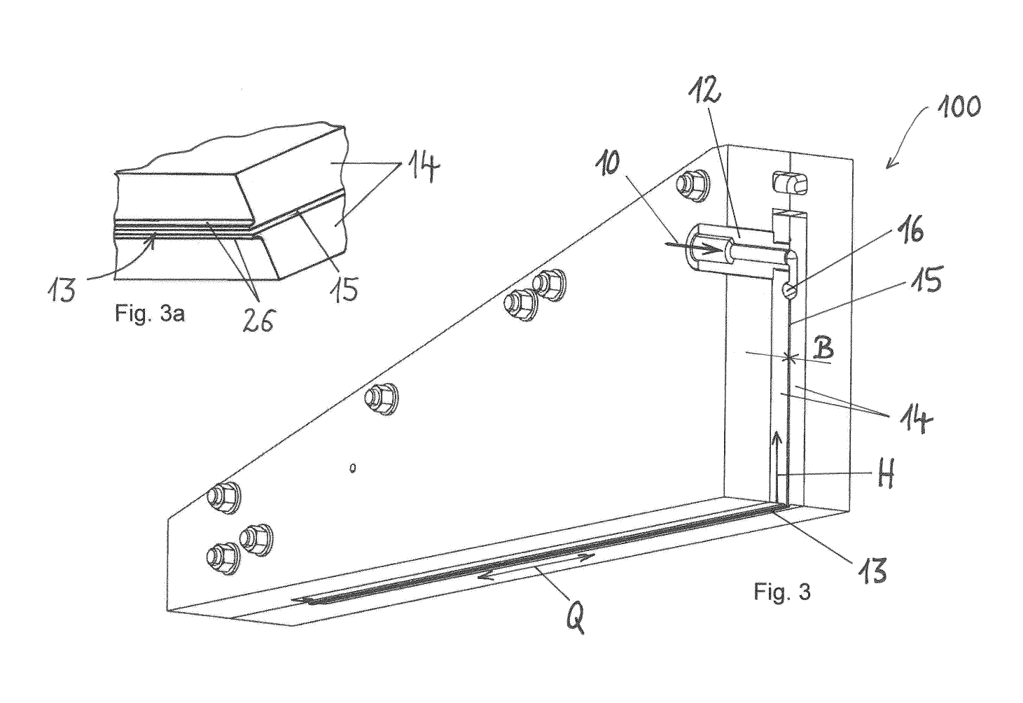

FIG. 3 a transversely sectional view of the pouring device with two slot plates arranged on one another, forming the slot space between the slot plates,

FIG. 3a shows a modified embodiment of the outlet slot with slot lips formed thereon,

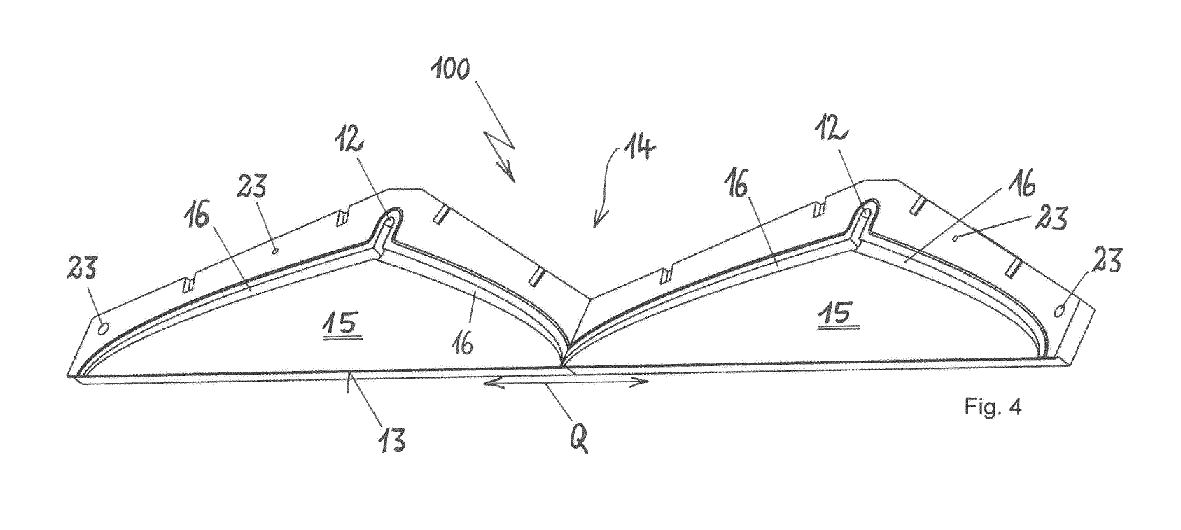

FIG. 4 is a perspective view of a continuous slot plate, which forms a plurality of individual pouring devices and

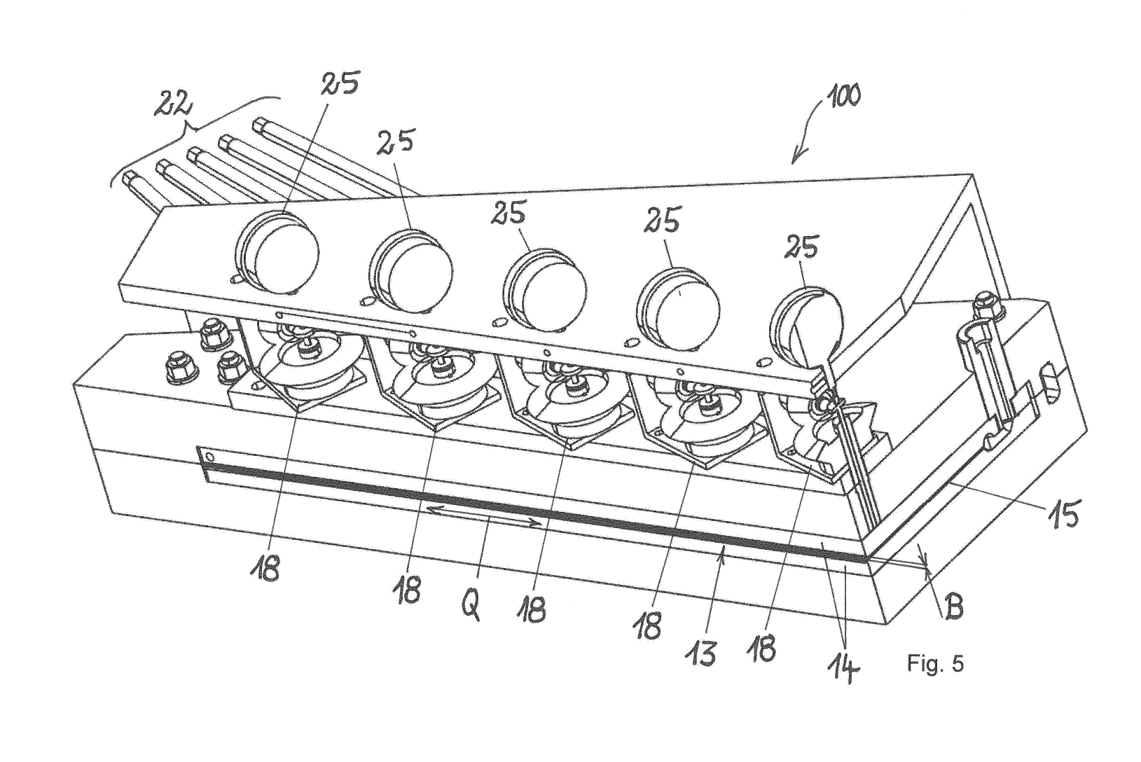

FIG. 5 is a perspective view of part of a pouring device with adjusting means arranged on the slot plates.

FIG. 1 shows a schematic view of an installation for operating a method which serves to produce composite elements 1. The installation comprises a double belt conveying installation 21 into which two facing layers 11 are fed. A lower facing layer 11 is uncoiled from a facing layer roller 20 and an upper facing layer 11 is likewise uncoiled from a further facing layer roller 20. The two facing layers 11 are introduced into the conveying installation 21 with a gap between them, and a reaction mixture 10 is applied to the inner surface of the lower facing layer 11 with a pouring device 100. The pouring device 100 adjoins a mixing head 19 via a feed port 12, and in the mixing head 19, represented by two arrows, at least the components polyol and isocyanate are input in an appropriate mixing ratio, wherein air loading of the reaction mixture 10 may possibly be provided, this not being shown merely for the purpose of simplification.

The pouring device 100 is positioned spaced from the double belt conveying installation 21 in such a way that the reaction mixture foams over a foaming distance such that the bottom of the upper facing layer 11 is reached by the foaming and, on passage of the composite element 1 formed in this way through the double belt conveying installation 21, the polyurethane foam core between the two facing layers 11 may cure. After passage through the double belt conveying installation 21, the endless material of the composite element 1 may be separated to form individual sandwich panels, in a manner not shown in any greater detail.

FIG. 2 shows an example of a slot plate 14, wherein the perspective representation is selected such that the slot space 15 is visible, wherein the counter slot plate has been removed in order to reveal the shallow slot space 15. The slot plate 14 shown comprises openings 23 for receiving fastening means, such that two slot plates 14 may be brought together in order to form the pouring device 100 and in order thereby to complete the slot space 15.

Shown by way of example is a feed port 12 for supplying reaction mixture 10, and the feed port 12 is connected for flow with a feed duct 16, which is introduced into the slot plate 14. Downstream of an intermediate duct 24 for connection to the feed port 12, the feed duct 16 branches off to both sides of a transverse direction Q, such that the feed duct 16 has two branches, which extend sideways away from the feed port 12.

Thus, a symmetrical configuration of the pouring device is shown merely by way of example which may alternatively also be formed asymmetrically on just one side of the feed port 12, such that just one branch of the feed duct 16 adjoins the feed port 12.

The lower edge of the slot plate 14 forms an outlet slot 13 together with the further slot plate 14, which is not shown. The outlet slot 13 extends lengthwise over the transverse direction Q between the two ends of the feed duct 16, and the feed duct 16 is curved in such a way that it approaches the edge of the outlet slot 13 as the distance from the feed port 12 increases and finally terminates therewith at the end. Thus, the greater is the distance from the feed port 12, the smaller the height of the slot space 15 becomes in the vertical direction H. The feed duct 16 itself is introduced as a groove-like recess in the slot plate 14 and has a duct cross-section 17 which tapers as the distance from the feed port 12 increases.

The changing duct cross-section 17, the curvature in the feed duct 16 and thus the changing height in the vertical direction H of the slot space 15 are matched to one another in such a way that the reaction mixture 10 experiences the same transit time through the pouring device 100 over the entire length of the outlet slot 13, and the discharge rate of the reaction mixture 10 out of the outlet slot 13 is likewise the same over the length of the entire outlet slot 13.

FIG. 3 shows a cross-sectional view through the pouring device 100 with cross-sectioned slot plates 14. In this case, a slot space 15 is visible, which extends between the two slot plates 14 and extends in the vertical direction H from the feed duct 16 to the bottom outlet slot 13. The slot space 15 has a constant width B over its two-dimensional extent, and the two-dimensional extent arises between the feed duct 16 and the outlet slot 13 in the vertical direction H and the transverse direction Q, to which the vertical direction H is perpendicular.

FIG. 3a shows a modified embodiment of the outlet slot 13 with slot lips 26 formed thereon, wherein the slot lips 26 project beyond the plate end of the slot plates 14 and form thin lip-like projections. This prevents reaction mixture from being able to accumulate in the outer region of the outlet slot 13, a situation which could interfere with discharge of the reaction mixture at the outer surface of the slot plates 14 if relatively large quantities were to accumulate.

FIG. 4 shows two individual pouring devices 100 arranged next to one another, these being arranged next to one another in such a way in the transverse direction Q that a single continuous outlet slot 13 arises. If the respective feed ports 12 are fed with reaction mixture 10, the reaction mixture 10 passes with the above-described advantages through the respective feed ducts 16 of the pouring devices 100 and exits via the common outlet slot 13 over twice the outlet length. The common outlet slot 13 extends in the same transverse direction Q for both pouring devices 100. Overall, it thus results in an increased linear width for application of the reaction mixture 10 in the case of individual slot spaces 15 of relatively small configuration, and for a width of the facing layer 11, for example with a width of 120 cm, it is not necessary to provide a single slot plate 14 with a continuous slot space 15 but rather multiple individual slot spaces 15 may be formed below associated feed ducts 16.

Finally, FIG. 5 further shows a perspective view of a part of the pouring device 100 with two slot plates 14 applied against one another and a slot space 15 formed between the slot plates 14. In order to adjust the outlet slot 13 with regard to the width B, a plurality of adjusting means 18 are arranged distributed in the transverse direction Q over the length of the outlet slot 13, which adjusting means may adjust an associated portion of the outlet slot 13 with regard to the width B via actuators 22. Through appropriate adjustment of the adjusting means 18 via the actuators 22, for example with an associated tool, the outlet slot 13 may be adjusted in regard to its width B such that the application uniformity of the reaction mixture 10 may be further improved. Associated dial gauges 25 in this case allow monitoring of the width B associated with the respective adjusting means 18.

The invention is not limited in embodiment to the above-stated preferred exemplary embodiments. Rather, a number of variants are conceivable which make use of the solution described even in the case of fundamentally different embodiments. All the features and/or advantages resulting from the claims, description or drawings, including structural details or spatial arrangements, may be essential to the invention both per se and in the most varied combinations.

### LIST OF REFERENCE NUMERALS

100 Pouring device
1 Composite element
10 Reaction mixture
11 Facing layer
12 Feed port
13 Outlet slot
14 Slot plate
15 Slot space
16 Feed duct
17 Duct cross-section
18 Adjusting means
19 Mixing head
20 Facing layer roller
21 Double belt conveying installation
22 Actuators
23 Opening
24 Intermediate duct
25 Dial gauge
26 Slot lip
Q Transverse direction
H Vertical direction
B Width

1. A pouring device for applying a foaming reaction mixture comprising at least polyol and isocyanate over at least part of a width of a facing layer, for producing a composite element, wherein the pouring device comprises:
a feed port for feeding in the reaction mixture,
at least one outlet slot extending in a transverse direction for discharge of the reaction mixture,
two mutually opposingly arranged slot plates, wherein a slot space extends between the slot plates in a vertical direction above the outlet slot, wherein
a feed duct connected to the feed port is formed between the slot plates, wherein the feed duct terminates the slot space above the outlet slot in the vertical direction, wherein
the feed duct comprises a duct cross-section with a main dimension which is greater than a width of the slot space, such that
the reaction mixture may be introduced into the slot space distributed over a length of the feed duct.

2. The pouring device as claimed in claim 1, wherein the duct cross-section is configured to become smaller as a distance from the feed port increases.

3. The pouring device as claimed in claim 1, wherein the slot space has a width which is formed constantly over substantially the entire two-dimensional extent of the slot space between the slot plates.

4. The pouring device as claimed in claim 1, wherein the feed duct is curved, such that a height of the slot space above the outlet slot becomes smaller as a distance from the feed port increases.

5. The pouring device as claimed in claim 4, wherein the curvature of the feed duct increases in magnitude as a distance from the feed port increases.

6. The pouring device as claimed in claim 1, wherein the changing duct cross-section of the feed duct and/or the curvature of the feed duct and/or the configuration of the slot space are determined in such a way that the discharge velocity of each element of volume of the reaction mixture has the same velocity value over a length of the outlet slot.

7. The pouring device as claimed in claim 1, wherein the changing duct cross-section of the feed duct and/or the curvature of the feed duct and/or the configuration of the slot space are determined in such a way that, relative to a length of the outlet slot, each element of volume of the reaction mixture displays the same transit time from the feed port to discharge from the outlet slot.

8. The pouring device as claimed in claim 1, wherein a length of the feed port and/or the length of the feed duct and/or a height of the slot space in the vertical direction above the outlet slot are determined in such a way that the transit time of the reaction mixture is less than the reaction time.

9. The pouring device as claimed in claim 1, further comprising adjusting means, wherein a width of the outlet slot is adjustable, and wherein a plurality of adjusting means are distributed over the length of the outlet slot.

10. An installation for applying a foaming reaction mixture at least comprising polyol and isocyanate over at least part of the width of a facing layer, for producing a composite element, comprising a plurality of pouring devices as claimed in claim 1, wherein the outlet slots of the pouring devices extend in a common transverse direction or over an arch over the facing layer.

11. The installation as claimed in claim 10, wherein the slot plates of the plurality of pouring devices are configured together in one piece on each side of the slot space.

12. The installation as claimed in claim 10, wherein the ends remote from the feed ports of the feed ducts of the plurality of pouring devices adjoin one another.

13. The installation as claimed in claim 10, wherein the installation comprises a gas loading device.

14. The installation as claimed in claim 10, wherein gas loading is performed using a gas selected from the group consisting of air, nitrogen, carbon dioxide, noble gas, and combinations of any thereof.

15. The installation as claimed in claim 13, wherein the reaction mixture is loaded with a gas.

16. The installation as claimed in claim 10, wherein gas loading is performed using a gas selected from the group consisting of argon, helium, and combinations of any thereof.
